(19) United States
(12) Patent Application Publication
(10) Pub. No.: US 2021/0296011 A1
(43) Pub. Date: Sep. 23, 2021

(54) DEVICE AND COMPOSITIONS OF MATTER FOR ENERGIZING SELF-SUSTAINING REACTIONS IN SOLID STATE MATERIAL

(71) Applicant: Tionesta Applied Research Corporation, Sequim, WA (US)

(72) Inventors: Anthony C. Zuppero, Escondido, CA (US); Thomas J. Dolan, Ionia, IA (US); William D. Jansen, Cary, NC (US); Paul Sturrock, Austin, TX (US); Paul A. Crone, Sequim, WA (US); William J. Saas, Westlake, OH (US)

(73) Assignee: Tionesta Applied Research Corporation, Sequim, WA (US)

(21) Appl. No.: 17/224,972

(22) Filed: Apr. 7, 2021

Related U.S. Application Data
(63) Continuation-in-part of application No. 15/973,231, filed on May 7, 2018, now abandoned.
Application No. 15/973,231 is a continuation-in-part of application No. 15/286,354, filed on Oct. 5, 2016, now abandoned.
Application No. 15/286,354 is a continuation-in-part of application No. 14/933,487, filed on Nov. 5, 2015, now abandoned.
Application No. 14/933,487 is a continuation-in-part of application No. PCT/US2015/059218, filed on Nov. 5, 2015.
(60) Provisional application No. 62/237,249, filed on Oct. 5, 2015.
(60) Provisional application No. 62/237,235, filed on Oct. 5, 2015.
(60) Provisional application No. 62/075,587, filed on Nov. 5, 2014.
(60) Provisional application No. 62/237,235, filed on Oct. 5, 2015.
(60) Provisional application No. 62/075,587, filed on Nov. 5, 2014.
(60) Provisional application No. 62/237,235, filed on Oct. 5, 2015.

(51) Int. Cl. G21B 1/21; G21G 7/00; G21B 1/19

(52) U.S. Cl. CPC G21B 1/21; B82Y 25/00; G21B 1/19; G21G 7/00

(57) ABSTRACT

A composition of matter including a fuel comprising one or more of isotopes of hydrogen or isotopes of lithium. The general binding reactions comprise electron-catalyzed chemical, molecular, or transmutation binding reactions. The composition also includes one or more reactants having an energy-releasing binding energy with the fuel. The fuel is associated with the general binding reactions with the one or more reactants. The composition additionally includes a reservoir capable of releasing one or more of molecular fuel or mono-atomic fuel when the reservoir is heated. The reservoir comprises one or more of the fuel or precursors to the fuel, such as a chemical form of fuel in the reservoir material. The composition further includes a fuel-cracking material capable of converting a fraction of the molecular fuel into mono-atomic fuel. The composition additionally includes a reaction crystallite on or in which general binding reactions are capable of being stimulated to occur. The composition further includes a spacer. Upon the one or more reaction capsule emissions of one or more of the proximate reaction capsules, the fuel is released from the reservoir, the fuel-cracking material is brought to operating temperature, a temperature of the reaction crystallite is raised sufficient to cause crystal momentum injection, electrons are tailored by the energy-releasing binding energy and the crystal momentum injections into the reactant crystallite, and an emission of the reaction capsule energizes one or more of the proximate reaction capsules to cause a self-sustaining or chain reaction. Other embodiments are described.

### CROSS-REFERENCE TO RELATED APPLICATIONS

This patent application is a continuation-in-part of U.S. patent application Ser. No. 15/973,231, filed May 7, 2018, which is a continuation-in-part of U.S. patent application Ser. No. 15/286,354, filed Oct. 5, 2016, which claims the benefit of U.S. Provisional Application No. 62/237,249, filed Oct. 5, 2015, and U.S. Provisional Application No. 62/237,235, filed Oct. 5, 2015. U.S. patent application Ser. No. 15/286,354 also is a continuation-in-part of U.S. patent application Ser. No. 14/933,487, filed Nov. 5, 2015, and International Patent Application No. PCT/US2015/59218, filed Nov. 5, 2015. U.S. patent application Ser. No. 14/933,487 and International Patent Application No. PCT/US2015/59218 each claim the benefit of U.S. Provisional Application No. 62/075,587, filed Nov. 5, 2014, and U.S. Provisional Application No. 62/237,235. This patent application also claims the benefit of U.S. Provisional Application No. 63/016,915, filed Apr. 28, 2020, and U.S. Provisional Application No. 63/035,587, filed Jun. 5, 2020.

International Patent Application Nos. PCT/US2019/031201 and PCT/US2015/59218; U.S. patent application Ser. Nos. 15/973,231, 15/286,354, and 14/933,487; and U.S. Provisional Application Nos. 63/035,587, 63/016,915, 62/237,249, 62/237,235, and 62/075,587 are incorporated herein by reference in their entirety. If there are any conflicts or inconsistencies between this patent application and these incorporated applications, this patent application governs herein.

### TECHNICAL FIELD

This disclosure relates generally to systems, devices, compositions of matter and methods to cause a self-sustaining binding reaction in certain solid state systems emitting energetic ions and energy, which exploits the new field of electron catalysis of general binding reactions. An initiating mechanism causes a composition of matter to emit particles and radiation to adjacent regions also containing the composition. The adjacent compositions are configured to react as if initiated by the initiating mechanism and exhibit self-sustaining reactions in systems emitting highly energetic products, including systems used as seldom as once.

### DESCRIPTION OF THE BACKGROUND

Multiple, different groups (Fralick 2020, Boss U.S. Pat. No. 8,419,919, Mizuno 2005, Mills WO2019111164A1) have reported a reaction that has been observed to release enough energy to melt refractory materials and to concentrate and/or produce energetic novel isotopes upon stimulation by one or more of several different chemical mechanisms and to emit a significant amount of energy upon reaction.

While the reaction itself is not known, the stimulation and trigger of the reaction has been documented by the multiple, different groups. Each of the different mechanisms used to trigger the reported reactions appears to energize a common feature known to accelerate reactions.

One mechanism used atomic hydrogen to initiate binding reactions, with a source of atomic hydrogen being continuously replenished. Experiments provided a continuous source of atomic hydrogen during the period of a stimulation phase. Another mechanism used the disintegration/reintegration of reaction crystallite and adsorption/desorption of atoms, chunks, and molecules to tailor electron properties and initiate reactions.

Accordingly, it would be advantageous to have a device and composition of matter that replenishes atomic hydrogen and/or causes disintegration/reintegration. It would be advantageous for the products of one reaction to stimulate another, nearby reaction, thereby causing a self-sustaining reaction.

### BRIEF DESCRIPTION OF THE DRAWINGS

To facilitate further description of the embodiments, the following drawings are provided in which:

FIG. 1 illustrates a general reaction capsule with complex features whose contents undergo reaction when stimulated, and emit stimulating radiation, which may be charged particles, neutral particles, electromagnetic waves, or phonons;

FIG. 2 illustrates a simply constructed reaction capsule; and

FIG. 3 illustrates a simply energized reaction capsule.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

The terms “couple,” “coupled,” “couples,” “coupling,” and the like should be broadly understood and refer to connecting two or more elements or signals, electrically, mechanically and/or otherwise. Two or more electrical elements may be electrically coupled together, but not be mechanically or otherwise coupled together; two or more mechanical elements may be mechanically coupled together, but not be electrically or otherwise coupled together; two or more electrical elements may be mechanically coupled together, but not be electrically or otherwise coupled together. Coupling may be for any length of time, e.g., permanent or semi-permanent or only for an instant. “Electrical coupling” and the like should be broadly understood and include coupling involving any electrical signal, whether a power signal, a data signal, and/or other types or combinations of electrical signals. “Mechanical coupling” and the like should be broadly understood and include mechanical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

### DETAILED DESCRIPTION OF EXAMPLES OF EMBODIMENTS

A number of embodiments, include a composition of matter for a reaction capsule capable of enabling a fraction of contents of the reaction capsule to undergo general binding reactions when stimulated by one or more reaction capsule emissions of proximate reaction capsules. The composition of matter includes a fuel comprising one or more of isotopes of hydrogen or isotopes of lithium. The general binding reactions comprise electron-catalyzed chemical, molecular, or transmutation binding reactions. The composition of matter also includes one or more reactants having an energy-releasing binding energy with the fuel. The fuel is associated with the general binding reactions with the one or more reactants. The composition of matter additionally includes a reservoir capable of releasing one or more of molecular fuel or mono-atomic fuel when the reservoir is heated. The reservoir comprises one or more of the fuel or precursors to the fuel, such as a chemical form of fuel in the reservoir material. The composition of matter further includes a fuel-cracking material capable of converting a fraction of the molecular fuel into mono-atomic fuel. The composition of matter additionally includes a reaction crystallite on or in which general binding reactions are capable of being stimulated to occur. The composition of matter further includes a spacer. Upon the one or more reaction capsule emissions of one or more of the proximate reaction capsules, and/or upon one or more of a collection of nearby reaction capsules being initiated by an external stimulus having similar properties to properties of one or more of the reaction emissions, the fuel is released from the reservoir, the fuel-cracking material is brought to operating temperature, a temperature of the reaction crystallite is raised sufficient to cause crystal momentum injection, electrons are tailored by the energy-releasing binding energy and the crystal momentum injections into the reactant crystallite, and an emission of the reaction capsule energizes one or more of the proximate reaction capsules to cause a self-sustaining or chain reaction.

Various embodiments include a composition of matter for a reaction capsule capable of enabling a fraction of contents of the reaction capsule to undergo general binding reactions when stimulated by one or more reaction capsule emissions of proximate reaction capsules. The composition of matter includes a mono-atomic fuel comprising one or more of isotopes of hydrogen or isotopes of lithium. The general binding reactions comprise electron-catalyzed chemical, molecular, or transmutation binding reactions. The composition of matter also includes one or more reactants having an energy-releasing binding energy with the mono-atomic fuel. The mono-atomic fuel is associated with the general binding reactions with the one or more reactants. The composition of matter additionally includes a reservoir capable of releasing one or more of molecular fuel or the mono-atomic fuel when the reservoir is heated. The reservoir comprises one or more of the mono-atomic fuel or precursors to the mono-atomic fuel, such as a chemical form of fuel in the reservoir material. The composition of matter further includes a fuel-cracking material capable of converting a fraction of the molecular fuel into the mono-atomic fuel. The composition of matter additionally includes a reaction crystallite on or in which general binding reactions are capable of being stimulated to occur. The composition of matter further includes a spacer. Upon the one or more reaction capsule emissions of one or more of the proximate reaction capsules, and/or upon one or more of a collection of nearby reaction capsules being initiated by an external stimulus having similar properties to properties of one or more of the reaction emissions, the mono-atomic fuel is released from the reservoir, the fuel-cracking material is brought to operating temperature, a temperature of the reaction crystallite is raised sufficient to cause crystal momentum injection, electrons are tailored by the energy-releasing binding energy and the crystal momentum injections into the reactant crystallite, and an emission of the reaction capsule energizes one or more of the proximate reaction capsules to cause a self-sustaining or chain reaction.

Further embodiments include a device capable of enabling a fraction of contents of the device to undergo general binding reactions when stimulated by one or more reaction capsule emissions of proximate reaction capsules. The device includes a fuel comprising one or more of isotopes of hydrogen or isotopes of lithium. The general binding reactions comprise electron-catalyzed chemical, molecular, or transmutation binding reactions. The device also includes one or more reactants having an energy-releasing binding energy with the fuel. The fuel is associated with the general binding reactions with the one or more reactants. The device additionally includes a reservoir capable of releasing one or more of molecular fuel or mono-atomic fuel when the reservoir is heated. The reservoir comprises one or more of the fuel or precursors to the fuel, such as a chemical form of fuel in the reservoir material. The device further includes a fuel-cracking material capable of converting a fraction of the molecular fuel into mono-atomic fuel. The device additionally includes a reaction crystallite on or in which general binding reactions are capable of being stimulated to occur. The device further includes a spacer. Upon the one or more reaction capsule emissions of one or more of the proximate reaction capsules, and/or upon one or more of a collection of nearby reaction capsules being initiated by an external stimulus having similar properties to properties of one or more of the reaction emissions, the fuel is released from the fuel reservoir, the fuel is released from the reservoir, the fuel-cracking material is brought to operating temperature, a temperature of the reaction crystallite is raised sufficient to cause crystal momentum injection, electrons are tailored by the energy-releasing binding energy and the crystal momentum injections into the reactant crystallite, and an emission of the device energizes one or more of the proximate reaction capsules to cause a self-sustaining or chain reaction.

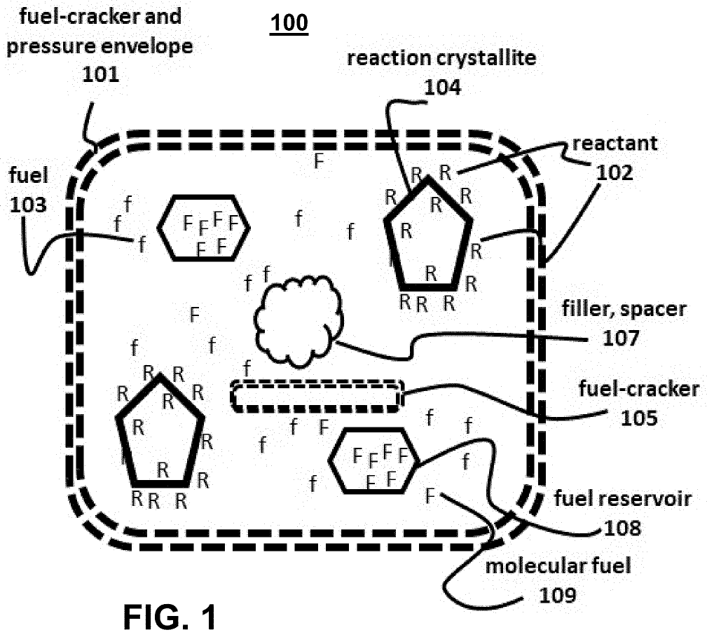

Turning to the drawings, FIG. 1 illustrates a system 100 showing a general reaction capsule with complex features enabling a fraction of the capsule contents to undergo general binding reactions when stimulated by one or more of the emissions of the reactions. System 100 is merely exemplary, and embodiments of the reaction capsule are not limited to the embodiments presented herein. The reaction capsule can be employed in many different embodiments or examples not specifically depicted or described herein. System 100 shows a general reaction capsule whose contents can undergo electron catalyzed binding reactions when energized by conventional and observed processes using the external electron to enable and cause the reaction. The first examples were free radicals such as H, O, OH, and CHO binding to the metal of a Schottky junction conductor, which provided catalytic electron quasi particles. Nienhauss was the first to have observed free radicals undergoing electron catalyzed binding reactions when catalyzed by substrate electron quasi particles.

Reactions include one or more observed chemical and binding reactions that release emissions of both charged and uncharged, energetic reaction products, intense infrared and optical radiation, phonons and free radicals.

A number of embodiments can provide self-sustaining or prolonging chain reaction. Reaction triggering and acceleration has been observed to occur when atomic hydrogen reacted with a reactant on a reaction crystallite. Theory and practice both indicate that the interaction of atomic hydrogen with the crystallite having a reactant on or near its surface may energize electrons in the first Brillouin zone of the band structure and tailor their properties.

Similarly, heating reactant crystallites to near or at melting temperature energizes electrons similarly when disintegration/reintegration and adsorption/desorption events occur in structurally failing crystallites.

These band structure processes energize some of electrons to be near inflection points, at which electron effective mass diverges. Both a theory and extensive observations suggest this may be responsible for the stimulation effects observed with the atomic hydrogen free radical reactions and in exploding systems.

The techniques described herein rely on observations of such emitted energies and reactions, and use them to cause further reactions.

The emitted reaction energy has been observed in some configurations to release in a sudden burst. The burst has caused explosions, bright light emission, and observed melting of refractory elements in a reaction region. The burst has been observed to vaporize a reaction region.

These energetic emissions can be energetic enough to reach nearby, similar reaction regions. Energy absorption by a fuel reservoir 108 releases fuel in the composition and brings an adjacent fuel cracker 105 to cracking temperature, causing reactions. Energy absorption to the point of crystal momentum generation in the neighboring reaction crystallites energizes reactions. These events provide a self-sustaining reaction or a reaction that extends the duration of the reaction.

The capsule includes a pressure containment and fuel-cracking envelope 101, a composition of matter comprising a reactant 102 in or on a reaction crystallite 104, fuel 103 (“f”) associated with the reactant 102 whether molecular fuel 109 (“F”) or dissociated into free radicals 103 (“f”), fuel reservoir 108, a fuel-cracking element 105 which may also be part of an envelope 101, and a filler or spacer 107.

When one or more of a collection of such capsules are initiated by an external stimulus similar to the reaction emissions, one capsule's emission may energize adjacent or nearby capsules to undergo similar reactions and emissions. This provides a self-sustaining or chain reaction.

The envelope may also be formed as a transient containment vessel to partially contain an overpressure of hot gas that may develop inside the capsule. For example approximately 2 nm (nanometers) to approximately 500 nm thickness films of tungsten, palladium and other metals are examples of many known such materials.

The envelope 101 preferably can contain a fuel-cracking material on its outer surface. When heated to an operating temperature, the envelope cracks hydrogen gas into atomic hydrogen (free radicals). Tungsten and its oxides are another example of the many known fuel-cracking materials. Other fuel-cracking methods comprise one or more of a focused laser, a bridge wire initiator, an intense microwave beam, an electric arc in hydrogen gas using higher amperage (e.g. 10 amps) and lower voltage (e.g. 3 Volts), and provide some examples of efficient energizing systems.

The binding potential may be general and not limited to the chemical binding of two chemicals by an electron. The contents of the capsule comprise a composition of matter (elements 102 through 109 of FIG. 1) that undergoes electron catalysis when suitably energized.

Some reaction crystallites 104 may become conductors even though initially they are non-conductors. For example, some insulators and semiconductors may become conductors when heated or bathed in intense light or electromagnetic radiation. For example, lanthanum-strontium titanate exhibits this property.

Crystallite conductivity may be transiently switched from non-conductor to conductor by energizing electrons to conduction bands using external energy sources such as lasers, x-ray and gamma sources, particle and electron beams or the energy of reaction in the capsule.

The reaction crystallite 104 may be made of any suitable material having a desirable band structure, in which thermally accessible inflection points appear in the first Brillouin zone. Some examples include vanadium, titanium, nickel, palladium, zirconium, calcium hydride, silver, some of their hydrides (VHx, TiHx) and some of their chemical compounds.

Experiments demonstrated that the crystallite need not incorporate reactants in the crystallite body, see Iwamura 2003, and Bush 1994, and may react with compounds of the reactant on the surface of the crystallite.

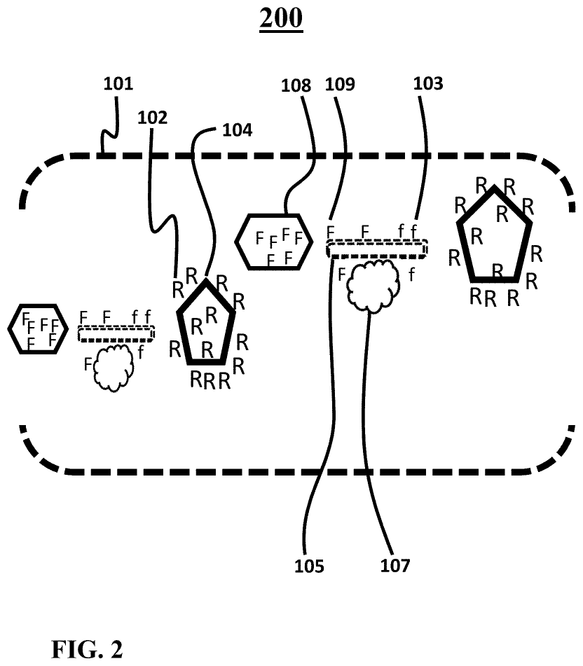

Turning ahead in the drawings, FIG. 2 illustrates a simply formed and constructed system 200, which can be a reaction capsule. For example, extruding reaction capsule contents into a tubular envelope (envelope 101) may permit energizing it to cracking temperatures using an electrical input across the length of the tube. This construction permits filling the volume with the composition of matter of system 100 (FIG. 1), such as elements 102-109, in a continuous manufacturing process.

By energizing system 100 (FIG. 1) or system 200 (FIG. 2), an initiation may start a chain reaction in a collection of reaction capsules adjacent to each other.

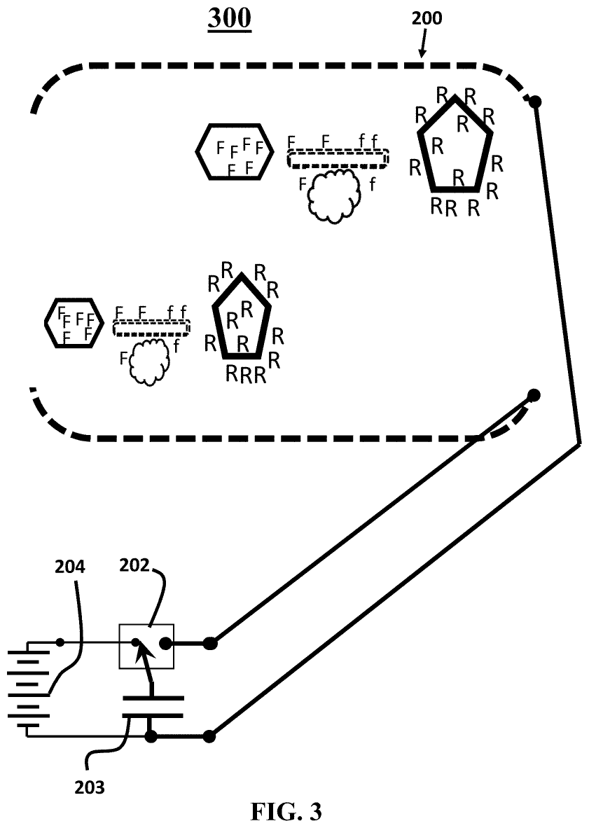

Turning ahead in the drawings, FIG. 3 illustrates a system 300 showing a simple method to bring the fuel-cracker on the envelope to operating temperature. An external capacitor discharge system uses a capacitor 203 charged by some source 204 and discharged by closing a fast switch 202 to energize system 200. A focused, short pulse laser may also heat the envelope to cracking temperature.

An alternative method of initiation is to bathe any of the described capsules, such as system 100, 200, and/or 300, in atomic hydrogen free radicals. Such free radicals may be conveniently formed in atmospheric pressure hydrogen by passing a high current (e.g. 10 amps) at a low voltage (e.g. 3 volts) through the hydrogen. A brief, higher voltage (e.g. greater than about 200 volts) pulse may be used to form a gaseous conduction path for the low voltage high current discharge. Another, well-known alternative to create a bath of atomic hydrogen includes microwave discharge in hydrogen gas.

The composition of matter may, without envelope 101, may use its fuel-cracking element 105 to perform the energy absorbing function of the envelope to achieve fuel cracking. When an envelope is not included, the “reaction capsule” consists of the composition of matter comprising 102 thru 109 (FIG. 1-2).

The reactants 102 of the composition of matter may be chosen from nearly any element or isotope in the periodic table so long as the combination of fuels and reactants have a negative binding energy. Those fuel-reactant combinations may undergo electron catalysis (electron stimulated binding) causing a release of binding energy. The reactants 102 may be in nearly any chemical form, for example, oxides, chlorides and carbonates, which expose the reactants to a reaction crystallite surface.

Aerogels may incorporate reactants and may serve as reaction crystallites, spacers, and fuel crackers. For example, aerogels may be made from reactants silica, most of the transition metal oxides (for example, iron oxide), lanthanide and actinide metal oxides (for example, praseodymium oxide), several main group metal oxides (for example, tin oxide) organic polymers (such as resorcinol-formaldehyde, phenol-formaldehyde, polyacrylates, polystyrenes, polyurethanes, and epoxies), biological polymers (such as gelatin, pectin, and agar agar), semiconductor nanostructures (such as cadmium selenide quantum dots), carbon, carbon nanotubes and/or metals (such as copper and gold).

When energized, the capsules may confine the composition of matter by inertial confinement rather than by the tensile strength of a confining envelope. Inertial confinement by the capsule may not only be effective but also desirable because it prolongs the time during which reaction crystallites disintegrate and re-integrate and during which fuel and reactants adsorb and desorb from reaction crystallites body and surface. These disintegration/re-integration, adsorb/desorb processes have been observed to modulate the properties of electrons in a way to accelerate electron catalysis.

For example, form an envelope with thickness from approximately 2 nm to approximately 500 nm. Such films typically exhibit relatively high tensile strength. Materials such as graphenes and equivalent, continuous, ultra-thin metal films with thicknesses down to 2 nm may be used. Such films are commercially available and include Pd, C, W, and Pt films.

Optionally include films with thickness well above the clumping limit of approximately 15 nm, for example nickel, aluminum and other materials forming films greater than 30 nm in thickness. Optionally, include multiple envelopes whether of similar or different compositions. Optionally, include envelopes which may “leak a little” and only approximately contain the composition of matter.

Using thin envelopes permits highly energetic particles to retain a majority of their energy as they exit the reaction capsule.

The envelope may be thin enough that it is breached before complete melting of capsule contents. The breaching expansion acts like a transient cooling of molten nano-fragments, causing transient solidification into crystallites of nm size, which can be a desirable size. The phonon waves in such transient crystals have wavelengths placing some crystal momentum waves into the first Brillouin zone and thereby resulting in desirable modulation of some electron quasi particle effective masses. Alternatively, an envelope may be sufficiently robust to delay breach of contents until self-destruction of capsule contents occurs. During destruction, multiple crystal momentum injection events can occur.

The reaction capsule may be used as source of impulse. The general binding reactions have undergone unexpected explosions. An explosion delivers an impulse to a mass it encounters. When the explosion includes an ionized gas passed through the field of a magnetic nozzle, the impulse is against the mass of the device creating the field. When the mass is a turbine blade or a rocket nozzle, propulsion and rotary power may be extracted. All of these deliver impulses which can be converted into rotary shaft power, can energize magneto hydrodynamic processes to generate electricity and thrust, and rocket propulsion.

In these applications, as stream of reaction capsules may be directed into to focal regions of the impulse accepting masses, and energized when they reach the regions.

Although systems, devices, compositions of matter, and methods for energizing self-sustaining reactions in solid state materials have been described with reference to specific embodiments, it will be understood by those skilled in the art that various changes may be made without departing from the spirit or scope of the invention. Accordingly, the disclosure of embodiments of the invention is intended to be illustrative of the scope of the invention and is not intended to be limiting. It is intended that the scope of the invention shall be limited only to the extent required by the appended claims. For example, to one of ordinary skill in the art, it will be readily apparent that (a) various elements of FIGS. 1-3 herein may be modified, combined with each other, and/or interchanged with each other, and (b) the embodiments described with reference to FIGS. 1-3 do not necessarily represent a complete description of all possible embodiments.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are expressly stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A composition of matter for a reaction capsule capable of enabling a fraction of contents of the reaction capsule to undergo general binding reactions when stimulated by one or more reaction capsule emissions of proximate reaction capsules, the composition of matter comprising:
a fuel comprising one or more of isotopes of hydrogen or isotopes of lithium, wherein the general binding reactions comprise electron-catalyzed chemical, molecular, or transmutation binding reactions;
one or more reactants having an energy-releasing binding energy with the fuel, wherein the fuel is associated with the general binding reactions with the one or more reactants;
a reservoir capable of releasing one or more of molecular fuel or mono-atomic fuel when the reservoir is heated, wherein the reservoir comprises one or more of the fuel or precursors to the fuel;
a fuel-cracking material capable of converting a fraction of the molecular fuel into mono-atomic fuel;
a reaction crystallite on or in which general binding reactions are capable of being stimulated to occur; and
a spacer;
wherein:
upon the one or more reaction capsule emissions of one or more of the proximate reaction capsules, the fuel is released from the reservoir, the fuel-cracking material is brought to operating temperature, a temperature of the reaction crystallite is raised sufficient to cause crystal momentum injection, electrons are tailored by the energy-releasing binding energy and the crystal momentum injections into the reactant crystallite, and an emission of the reaction capsule energizes one or more of the proximate reaction capsules to cause a self-sustaining or chain reaction.

2. A composition of matter for a reaction capsule capable of enabling a fraction of contents of the reaction capsule to undergo general binding reactions when stimulated by one or more reaction capsule emissions of proximate reaction capsules, the composition of matter comprising:
a mono-atomic fuel comprising one or more of isotopes of hydrogen or isotopes of lithium, wherein the general binding reactions comprise electron-catalyzed chemical, molecular, or transmutation binding reactions;
one or more reactants having an energy-releasing binding energy with the mono-atomic fuel, wherein the mono-atomic fuel is associated with the general binding reactions with the one or more reactants;
a reservoir capable of releasing one or more of molecular fuel or the mono-atomic fuel when the reservoir is heated, wherein the reservoir comprises one or more of the mono-atomic fuel or precursors to the mono-atomic fuel;
a fuel-cracking material capable of converting a fraction of the molecular fuel into the mono-atomic fuel;
a reaction crystallite on or in which general binding reactions are capable of being stimulated to occur; and
a spacer;
wherein:
upon the one or more reaction capsule emissions of one or more of the proximate reaction capsules, the mono-atomic fuel is released from the reservoir, the fuel-cracking material is brought to operating temperature, a temperature of the reaction crystallite is raised sufficient to cause crystal momentum injection, electrons are tailored by the energy-releasing binding energy and the crystal momentum injections into the reactant crystallite, and an emission of the reaction capsule energizes one or more of the proximate reaction capsules to cause a self-sustaining or chain reaction.

3. The composition of matter of claim 2, wherein an outer surface of an envelope of the reaction capsule comprises a fuel-cracking material.

4. The composition of matter of claim 2, wherein the reaction crystallite comprises nanoparticles of size approximately 2 nm to approximately 500 nm.

5. The composition of matter of claim 2, wherein the reaction crystallite comprises elements having an energy-releasing binding energy when reacted with the mono-atomic fuel.

6. The composition of matter of claim 2, wherein the reaction crystallite comprises one or more of Titanium, Nickel, Tungsten, Copper, Zirconium, Uranium, Thorium, Palladium, Platinum, Silver, Lanthanides, Actinides, or chemical compounds thereof.

7. The composition of matter of claim 2, wherein the fuel-cracking material comprises one or more of Tungsten, Nickel, Iron, carbon-coated Nickel, Molybdenum, Tantalum, Vanadium, or oxides thereof.

8. The composition of matter of claim 2, wherein an envelope mass generally surrounds a region comprising the composition and is configured to delay dispersal of contents of the region by inertial confinement.

9. The composition of matter of claim 8, wherein the envelope mass comprises an approximately 2 nm to approximately 500 nm impermeable film comprising a second fuel-cracking material.

10. The composition of matter of claim 9, wherein the second fuel-cracking material comprises one or more of tungsten or tungsten oxide.

11. The composition of matter of claim 2, wherein the one or more reactants comprises one or more materials of Sodium, Potassium, Rubidium, Aluminum, Magnesium, Silicon, Calcium, Strontium, Cesium, Zirconium, Tungsten, Thorium, Uranium, or chemical compounds thereof.

12. The composition of matter of claim 2, wherein the spacer comprises an aerogel.

13. The composition of matter of claim 2, wherein the reservoir comprises one or more of:
LiAlH₄;
NaBH₄;
hydrides of lithium, sodium, or aluminum; or
Vanadium, Titanium, Nickel, Aluminum, Calcium, Palladium, Zirconium, or hydrides thereof.

14. A device configured to impart momentum to an object comprising the composition of matter of claim 2 and impart an initial stimulus configured to initiate reactions in the composition of matter, wherein the device is configured to allow a rapid reaction initiated by the initial stimulus to expand against a momentum-catching object comprising a mass, a turbine blade, a rocket nozzle, or a magnetic nozzle.

15. The device of claim 14, wherein the initial stimulus comprises a laser beam sufficiently energetic to bring a 20-micron-across, 100-nm-thick spot of fuel-cracking material to a white-hot temperature while the composition of matter is immersed in hydrogen gas, or a 1 mJ per laser pulse delivering approximately 3 megawatts per square centimeter per laser pulse.

16. The device of claim 14, wherein the initial stimulus comprises one or more of:
a microwave beam configured to dissociate a region comprising hydrogen gas or a 1 cubic millimeter (mm) volume of hydrogen gas to monoatomic hydrogen in a configuration immersing the composition of matter in hydrogen;
a mono-atomic gas of hydrogen or its isotopes in contact with the composition of matter;
an electric current passing through the composition of matter and imparting sufficient energy to develop an arc;
a beam of energetic ions; or
a laser beam with sufficient energy to vaporize a target region of the reaction capsule comprising a fuel-cracking material.

17. A device capable of enabling a fraction of contents of the device to undergo general binding reactions when stimulated by one or more reaction capsule emissions of proximate reaction capsules, the device comprising:
a fuel comprising one or more of isotopes of hydrogen or isotopes of lithium, wherein the general binding reactions comprise electron-catalyzed chemical, molecular, or transmutation binding reactions;
one or more reactants having an energy-releasing binding energy with the fuel, wherein the fuel is associated with the general binding reactions with the one or more reactants;
a reservoir capable of releasing one or more of molecular fuel or mono-atomic fuel when the reservoir is heated, wherein the reservoir comprises one or more of the fuel or precursors to the fuel;
a fuel-cracking material capable of converting a fraction of the molecular fuel into mono-atomic fuel;
a reaction crystallite on or in which general binding reactions are capable of being stimulated to occur; and
a spacer;
wherein:
upon the one or more reaction capsule emissions of one or more of the proximate reaction capsules, the fuel is released from the reservoir, the fuel-cracking material is brought to operating temperature, a temperature of the reaction crystallite is raised sufficient to cause crystal momentum injection, electrons are tailored by the energy-releasing binding energy and the crystal momentum injections into the reactant crystallite, and an emission of the device energizes one or more of the proximate reaction capsules to cause a self-sustaining or chain reaction.

18. The device of claim 17, wherein:
an outer surface of an envelope of the device comprises the fuel-cracking material;
the fuel-cracking material comprises one or more of Tungsten, Nickel, Iron, carbon-coated Nicket, Molybdenum, Tantalum, Vanadium, or oxides thereof;
the reaction crystallite comprises nanoparticles of size approximately 2 nm to approximately 500 nm;
the reaction crystallite comprises elements having an energy-releasing binding energy when reacted with the mono-atomic fuel;
reaction crystallite comprises one or more of Titanium, Nickel, Tungsten, Copper, Zirconium, Uranium, Thorium, Palladium, Platinum, Silver, Lanthanides, Actinides, or chemical compounds thereof;
the reservoir comprises one or more of LiAlH₄, VHx, TiHx, PdHx, or NaBH₄;
the one or more reactants comprises one or more materials of Sodium, Potassium, Rubidium, Aluminum, Magnesium, Silicon, Calcium, Strontium, Cesium, Zirconium, Tungsten, Thorium, Uranium, or chemical compounds thereof; and
the spacer comprises an aerogel.

19. The device of claim 17, wherein the device is configured to deliver an impulse to an object comprising a composition of matter and an initiation stimulation device capable of action at a distance.

20. The device of claim 19, wherein the initiation stimulus device comprises one or more of:
a microwave beam configured to dissociate an approximately 1 cubic millimeter (mm) volume of hydrogen gas to monoatomic hydrogen while the approximately 1 cubic mm volume is in contact with the composition of matter
a mono-atomic hydrogen gas or its isotopes in contact with the composition of matter;
an electric current passing through the composition of matter;
a beam of energetic ions; or
a laser beam with sufficient energy to vaporize a target region of the device comprising a fuel-cracking material,
wherein:
wherein, upon stimulation, the device undergoes the self-sustaining or chain reaction and, with resulting vaporized materials of the self-sustaining or chain reaction, either energizes an electric generator comprising a magnetohydrodynamic (MHD) converter or expands against an object, imparting impulse, and thereby delivering momentum impulses to a momentum-catching object comprising a mass, a turbine blade, a rocket nozzle or a magnetic nozzle.
